(19) United States
(12) Patent Application Publication
(10) Pub. No.: US 2006/0137387 A1
(43) Pub. Date: Jun. 29, 2006

(54) Vapour compression heat pump system

(76) Inventors: Kare Aflekt, Trondheim (NO); Armin Hafner, Tronheim (NO); Arne Jakobsen, Trondheim (NO); Petter Neksa, Trondheim (NO); Jostein Pettersen, Trondheim (NO); Havard Rekstad, Trondheim (NO); Geir Skaugen, Trondheim (NO); Trond Andresen, Trondheim (NO); Espen Tondell, Trondheim (NO); Munan Elgsaether, Trondheim (NO)

Correspondence Address: WENDEROTH, LIND & PONACK, L.L.P., 2033 K STREET N. W., SUITE 800, WASHINGTON, DC, 20006-1021, US

(21) Appl. No.: 10/540,202

(22) PCT Filed: Dec. 17, 2003
(86) PCT No.: PCT/NO03/00424

§ 371 Date: Feb. 14, 2006

(30) Foreign Application Priority Data
Dec. 23, 2002 (NO) 2002623.3

(51) Int. Cl. F25B 41/00; C09K 5/04

(52) U.S. Cl. 62/513; 62/114

(57) ABSTRACT

A compression refrigeration system includes a compressor (1), a heat rejector (2), expansion means (3) and a heat absorber (4) connected in a closed circulation circuit that may operate with supercritical high-side pressure.

### FIELD OF INVENTION

The present invention relates to compression refrigeration system including a compressor, a heat rejector, an expansion means and a heat absorber connected in a closed circulation circuit that may operate with supercritical high-side pressure, using carbon dioxide or a mixture containing carbon dioxide as the refrigerant in the system.

### DESCRIPTION OF PRIOR ART AND BACKGROUND OF THE INVENTION

Conventional vapour compression systems reject heat by condensation of the refrigerant at subcritical pressure given by the saturation pressure at the given temperature. When using a refrigerant with low critical temperature, for instance CO₂, the pressure at heat rejection will be supercritical if the temperature of the heat sink is high, for instance higher than the critical temperature of the refrigerant, in order to obtain efficient operation of the system. The cycle of operation will then be transcritical, for instance as known from WO 90/07683.

WO 94/14016 and WO 97/27437 both describe a simple circuit for realising such a system, in basis comprising a compressor, a heat rejector, an expansion means and an evaporator connected in a closed circuit. CO₂ is the preferred refrigerant for both of them.

Heat rejection at super critical pressures will lead to a refrigerant temperature glide. This can be applied to make efficient hot water supply systems, e.g. known from U.S. Pat. No. 6,370,896 B1.

Ambient air is a cheap heat source which is available almost everywhere. Using ambient air as heat source, vapour compression systems often get a simple design which is cost efficient. However, at high ambient temperatures, the exit temperature of the compressor gets low, for instance around 70° C. for a trans-critial CO₂ cycle. Desired temperature of tap water is often 60-90° C. The exit temperature can be increased by increasing the exit pressure, but it will lead system performance will drop. Another drawback with increasing pressures is that components will be more costly due to higher design pressures.

Another drawback occurring at high ambient temperatures is that superheat of the compressor suction gas, which normally is provided by an internal heat exchanger (IHX), is not possible as long as evaporation temperature is higher than the heat rejector refrigerant outlet temperature. Hence, there is a risk for liquid entering the compressor.

A strategy to solve these problems is to regulate the evaporation temperature to always be below heat rejector refrigerant outlet temperature. This will make superheat of the suction gas possible and also increase the compressor discharge temperature for better hot water production, but the system energy efficiency will be poor since suction pressure will be lower than necessary.

U.S. Pat. No. 6,370,896 B1 presents a solution to these problems. The idea is to use a part of the heat rejector to heat the compressor suction gas. The full flow on the high pressure side is heat exchanged with the full flow on the low pressure side. This will ensure a superheat of compressor suction gas, and thereby secure safe compressor operation, but the system efficiency will drop compared to a system which compresses saturated gas (if possible) and which operates with a higher exit pressure to achieve a sufficient compressor discharge temperature. The suggested solution is hence more of operational importance.

### SUMMARY OF THE INVENTION

A major object of the present invention is to make a simple, efficient system that avoids the aforementioned shortcomings and disadvantages.

The invention is characterized by the features as defined in the accompanying independent claim 1.

Advantageous features of the invention are further defined in the accompanying independent claims 2-8.

The present invention is based on the system described above, comprising at least a compressor, a heat rejector, an expansion means and a heat absorber. By superheating the compressor suction gas temperature, the compressor exit temperature can be increased without increasing the exit pressure and hot water at desired temperatures can be produced. By using a split flow at appropriate temperature from the heat rejector, it is possible to superheat the compressor suction gas, for instance using a counterflow heat exchanger. After heating the compressor suction gas, the split flow is expanded directly to the low pressure side of the system. In this way, the two parts of the heat rejector will have different heating capacity per kilogram water flow due to lower flow in the latter part. It is hence possible to adapt a water heating temperature profile even closer to the refrigerant cooling temperature profile. Hot water can be produced with a lower high side pressure, and hence with a higher system efficiency.

### BRIEF DESCRIPTION OF THE DRAWINGS

The invention will be further described in the following by way of examples only and with reference to the drawings in which,

FIG. 1 illustrates a simple circuit for a vapour compression system,

FIG. 2 shows a temperature entropy diagram for carbon dioxide with examples of operational cycles for hot water production.

FIG. 3 a schematic diagram showing an example of a modified cycle to improve system performance and operating range.

FIG. 4 a schematic diagram showing another example of a modified cycle to improve system performance and operating range.

FIG. 5 shows a temperature entropy diagram for carbon dioxide with examples of temperature profiles for the heat rejector.

### DETAILED DESCRIPTION OF THE INVENTION

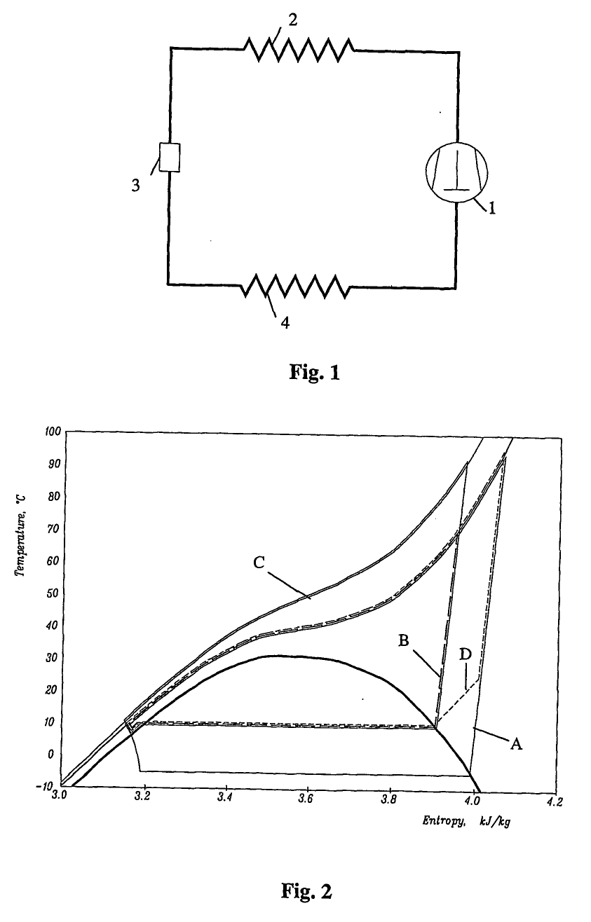

FIG. 1 illustrates a conventional vapour compression system comprising a compressor 1, a heat rejector 2, an expansion means 3 and a heat absorber 4 connected in a closed circulation system. When using for instance CO₂ as refrigerant, the high-side pressure will normally be supercritical in hot water supply systems in order to achieve efficient hot water generation in the heat rejector, illustrated by circuit A in FIG. 2. Desired tap water temperatures are often 60-90° C., and the refrigerant inlet temperature to the heat rejector 2, which is equal or lower than the compressor discharge temperature, has to be above desired hot water temperature.

Ambient air is often a favourable alternative as heat source for heat pumps. Air is available almost everywhere, it is inexpensive, and the heat absorber system can be made simple and cost efficient. However, at increasing ambient temperatures, the evaporation temperature will increase and the compressor discharge temperature will drop if compressor discharge pressure is constant, see circuit B in FIG. 2. The compressor discharge temperature may drop below desired tap water temperature. Tap water production at desired temperature will then be impossible without help from other heat sources.

One way to increase discharge temperature is to increase high side pressure, see circuit C in FIG. 2. But this will cause a reduction of system efficiency.

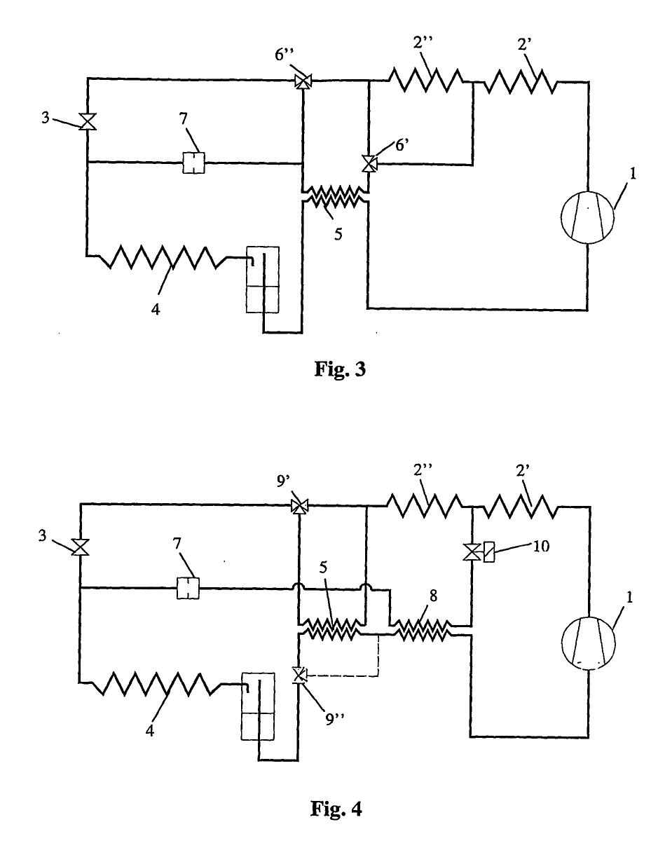

A conventional way to superheat the suction gas is to use an Internal Heat Exchanger (IHX) 5, see FIG. 3. But for instance when heating tap water, the refrigerant is cooled down close to net water temperature, typically around 10° C., in the heat rejector (2). If the evaporation temperature is above this temperature, suction gas will be cooled down instead of superheated, see FIG. 2. Liquid would enter the compressor 1, causing severe problems. It is important to avoid using the IHX 5 when the evaporation temperature is equal or higher than the net water temperature.

The present invention will secure a suction gas superheat irrespective of ambient temperature. When the evaporation temperature, or other appropriate temperatures, reaches a predetermined level, a split stream from the heat rejector 2 at a suitable temperature, is carried to a heat exchanger, for instance a counterflow heat exchanger, for compressor suction gas heating. The compressor discharge temperature will increase, and hot water may be produced at high system efficiency, see circuit D in FIG. 2. After heating the compressor suction gas, the spilt stream is expanded directly down to the low pressure side.

### EXAMPLE 1

One possible arrangement for the invention is to lead the split stream through an already existing IHX 5. An arrangement for bypassing the main stream outside the IHX 5, and leading the split stream through the IHX 5, then has to be implemented. There are various solutions for this arrangement. One alternative is to use two three-way valves 6′ and 6″, as indicated in FIG. 3. One or both of three-way valves may for instance be replaced by two stop valves. The split stream is expanded directly to the low pressure side through an orifice 7 downstream of the IHX 5. The orifice 7 may be replaced by other expansion means, and valves may be installed upstream and/or downstream of the-expansion mean for closer flow control through the expansion mean 7.

### EXAMPLE 2

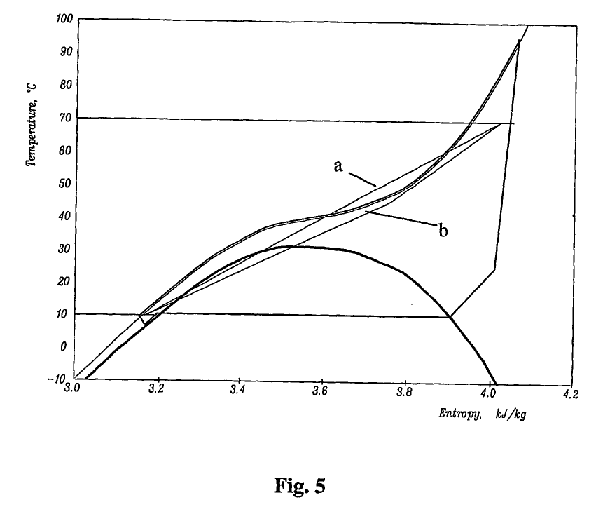

Another possibility is to install a separate heat exchanger 8, for instance a counterflow heat exchanger, for suction gas heating. This is illustrated in FIG. 4. When the evaporation temperature, or other usable temperatures, reaches a predetermined level, a split stream is carried through the suction gas heater 8 by opening the valve 10. This valve may be installed anywhere on the split stream line. The split stream is expanded directly to the low pressure side through an expansion mean, for instance an orifice 7 as indicated in FIG. 4. The IHX 5 can be avoided either by an arrangement on the high pressure side indicated be the three way valve 9′, or a equivalent arrangement on the low pressure side as indicated by dotted lines in figure X.

Suction gas superheat may be controlled by regulation of the spilt stream flow. This can for instance be performed by a metering valve in the split stream line. Another option is to apply a thermal expansion valve.

As explained above, the invention will improve the energy efficiency at high heat source temperatures, indicated by circuit D in FIG. 2. The reason is that by applying the present invention the high side pressure may be further reduced compared to what normally would be optimum pressure. This is illustrated in FIG. 5. The first part of the heat rejector 2′ will have a higher heating capacity relative to the water flow, compared to the latter part of the heat rejector 2″. The temperature profile for the water heating will be even better adapted to the cooling profile of the refrigerant, see water heating profile b in FIG. 5. Applying a conventional system will lead to the water heating profile a. As can be seen from FIG. 5, a temperature pinch will occur in the heat rejector 2. High side pressure will then have to be increased. With the present invention, it is possible to produce hot water at desired temperature with a lower high side pressure, leading to an even more energy efficient system.

1-8. (canceled)

9. A compression refrigeration system including at least a compressor (1), a heat rejector (2), an expansion means (3) and a heat absorber (4) connected in a closed circulation circuit that may operate with supercritical high-side pressure wherein the system heat pump efficiency can be improved by controlling the compressor suction gas superheat and that carbon dioxide or a refrigerant mixture containing carbon dioxide is applied as the refrigerant in the system.

10. System according to claim 9, wherein the superheat will be increased when the temperature of the heat source is above a predetermined level.

11. System according to claim 9, wherein the limitation for the superheat will be compressor discharge temperature, which can not exceed a predetermined level.

12. System according to claim 9, wherein the split stream from the heat rejector 2 is used for compressor suction gas superheating.

13. System according to claim 9, wherein the split stream from the high pressure side is expanded directly down to heat absorber pressure after suction gas heating.

14. System according to claim 9, wherein the split stream flow may be regulated in order to control suction gas superheat.

15. System according to claim 9, wherein the counterflow heat exchanger is used to heat the compressor suction gas.

16. System according to claim 9, wherein the counterflow heat exchanger may be a separate unit or the internal heat exchanger if already installed.
